(19) United States
(12) Patent Application Publication
(10) Pub. No.: US 2026/0064360 A1
(43) Pub. Date: Mar. 5, 2026

(54) AUDIO SETUP MANAGEMENT SYSTEM AND AUDIO SETUP MANAGEMENT METHOD THEREOF

(71) Applicant: QISDA (SUZHOU) CO., Ltd., Suzhou (CN)

(72) Inventor: Hong Mei Shi, Suzhou (CN)

(73) Assignee: QISDA (SUZHOU) CO., Ltd., Suzhou (CN)

(21) Appl. No.: 19/290,389

(22) Filed: Aug. 5, 2025

(30) Foreign Application Priority Data
Sep. 5, 2024 (CN) 202411245083.0

(51) Int. Cl. G06F 3/16

(52) U.S. Cl. CPC G06F 3/165

(57) ABSTRACT

The present invention provides an audio setup management system and an audio setup management method thereof. The audio setup management system includes a display module with a display surface. The display surface displays an audio setup including at least one setting. An audio module is coupled to the display module. A management module is coupled to the display module and the audio module. When one of the at least one setting is selected, the display surface displays a manual audio determination setting. When the management module selects a manual setting in the manual audio determination setting, the display surface displays audio options. When one of the audio options is selected, the management module controls the audio module to connect in response to the one of the audio options. Accordingly, a purpose of customizing a selection of each audio option can be achieved by manually operating the manual audio determination setting.

### BACKGROUND OF THE INVENTION

### 1. Field of the Invention

The present invention relates to an audio setup management system and an audio setup management method thereof, and more specifically, to a customized audio setup management system and an audio setup management method thereof.

### 2. Description of the Prior Art

More and more peripheral devices can be connected to smart electronic devices, and some of the peripheral devices support audio input or output, such as HDMI (High-Definition Multimedia Interface) monitor speakers, USB (Universal Serial Bus) cameras with built-in microphones, USB speakers, and built-in microphones and speakers of electronic devices. As a result, there are various combinations of audio input and/or output devices. Due to the complexity and diversity of smart terminal usage scenarios, users have differentiated preferences for audio input and output devices. For example, in conferencing scenarios, a user usually utilizes professional microphones rather than built-in microphones. Existing systems that automatically select audio input/output devices fail to meet the increasingly complex audio input/output requirements, resulting in a poor user experience. This issue particularly occurs in apparatuses which have multiple audio peripheral devices and are not conveniently accessible for frequent peripheral switching, such as audio machines mounted on meeting room walls. These apparatuses lack a direct mechanism to avoid the uncertainty of automatic audio device selection and cannot easily assign specific audio devices to specific usage scenarios.

Therefore, there is a need to design a novel audio setup management system and an audio setup management method thereof to solve the aforementioned problems.

### SUMMARY OF THE INVENTION

One purpose of the present invention is to provide an audio setup management system and an audio setup management method thereof, which can customize a selection of each audio option by manually operating a manual audio determination setting.

For achieving the aforesaid purpose, the present invention provides an audio setup management system including a display module, an audio module, and a management module. The display module has a display surface. The display surface displays an audio setup, wherein the audio setup includes at least one setting. The audio module is coupled to the display module. The management module is coupled to the display module and the audio module for controlling the display module and the audio module. After the management module selects one of the at least one setting from the audio setup, the display surface displays a manual audio determination setting. After the management module selects a manual setting from the manual audio determination setting, the display surface displays audio options. After the management module selects one of the audio options, the management module controls the audio module to connect in response to the one of the audio options.

Preferably, the audio module includes an audio output unit for audio output. The audio setup includes at least one audio output setting. After the management module selects one of the at least one audio output setting, the display surface displays a manual audio output determination setting. After the management module selects the manual setting from the manual audio output determination setting, the display surface displays audio output options. After the management module selects one of the audio output options, the management module controls the audio output unit to connect in response to the one of the audio output options.

Preferably, when none of the audio output options is enabled, the management module prompts to reselect at least one of the audio output options.

Preferably, when the manual setting in the manual audio output determination setting is not selected, the management module queries a list of pluggable audio output devices connected to the audio module. When the list is not empty, the management module selects a last connected audio output device from the list for audio output. When the list is empty, the management module selects a built-in audio output device for audio output.

Preferably, the audio module includes an audio input unit for audio input, the audio setup includes at least one audio input setting, and after the management module selects one of the at least one audio input setting, the display surface displays a manual audio input determination setting. After the management module selects the manual setting from the manual audio input determination setting, the display surface displays audio input options. After the management module selects one of the audio input options, the management module controls the audio input unit to connect in response to the one of the audio input options.

Preferably, when the manual setting in the manual audio input determination setting is not selected, the management module queries a list of pluggable audio input devices connected to the audio module, and selects a first-priority audio input device from the list for audio input.

The present invention further provides an audio setup management method applied to an audio setup management system. The audio setup management method includes selecting one of at least one setting from an audio setup, displaying a manual audio determination setting via a display surface, selecting a manual setting from the manual audio determination setting, displaying audio options via the display surface, selecting one of the audio options, and controlling an audio module to connect in response to the one of the audio options.

Preferably, the audio setup management method further includes selecting one of at least one audio output setting from the audio setup, displaying a manual audio output determination setting via the display surface, selecting the manual setting from the manual audio output determination setting, displaying audio output options via the display surface, selecting one of the audio output options, controlling an audio output unit to connect in response to the one of the audio output options and outputting audio via the audio output unit.

Preferably, the audio setup management method further includes prompting to reselect at least one of the audio output options when none of the audio output options is selected.

Preferably, the audio setup management method further includes querying a list of pluggable audio output devices connected to the audio module when the manual setting in the manual audio output determination setting is not selected, selecting a last connected audio output device for audio output when the list is not empty, and selecting a built-in audio output device for audio output when the list is empty.

Preferably, the audio setup management method further includes selecting one of at least one audio input setting from the audio setup, displaying a manual audio input determination setting via the display surface, selecting the manual setting from the manual audio input determination setting, displaying audio input options via the display surface, selecting one of the audio input options, controlling an audio input unit to connect in response to the one of the audio input options and inputting audio via the audio input unit.

Preferably, the audio setup management method further includes querying a list of pluggable audio input devices connected to the audio module when the manual setting in the manual audio input determination setting is not selected, and selecting a first-priority audio input device from the list for audio input.

Compared with the prior art, the present invention provides the audio setup management system and the audio setup management method thereof. The audio setup management system includes the display module, the audio module, and the management module. The display module has the display surface for displaying the audio setup including at least one setting. The audio module is coupled to the display module. The management module is coupled to the display module and the audio module for controlling the display module and the audio module. The management module selects one of the at least one setting from the audio setup. After the management module selects the one of the at least one setting from the audio setup, the display surface displays the manual audio determination setting. The management module then selects the manual setting from the manual audio determination setting, and the display surface displays the audio options. The management module selects one of the audio options and controls the audio module to connect in response to the one of the audio options. In such a manner, the purpose of customizing a selection of each audio option can be achieved by manually operating the manual audio determination setting.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an audio setup management system according to an embodiment of the present invention.

FIG. 2 is a diagram of an audio setup according to an embodiment of the present invention.

FIG. 3 is a diagram of a manual audio determination setting according to an embodiment of the present invention.

FIG. 4 is a diagram of audio options according to an embodiment of the present invention.

FIG. 5 is a diagram of an audio output setup according to an embodiment of the present invention.

FIG. 6 is a diagram of a manual audio output determination setting according to an embodiment of the present invention.

FIG. 7 is a diagram of audio output options according to an embodiment of the present invention.

FIG. 8 is a diagram of an audio input setup according to an embodiment of the present invention.

FIG. 9 is a diagram of a manual audio input determination setting according to an embodiment of the present invention.

FIG. 10 is a diagram of audio input options according to an embodiment of the present invention.

FIG. 11 is a flowchart of an audio setup management method according to an embodiment of the present invention.

FIG. 12 is a flowchart of an audio output setup management method according to one embodiment of the present invention.

FIG. 13 is a flowchart of an audio input setup management method according to one embodiment of the present invention.

### DETAILED DESCRIPTION

For providing a further understanding of purposes, structures, features and functions of the present invention, detailed description is given in conjunction with following embodiments.

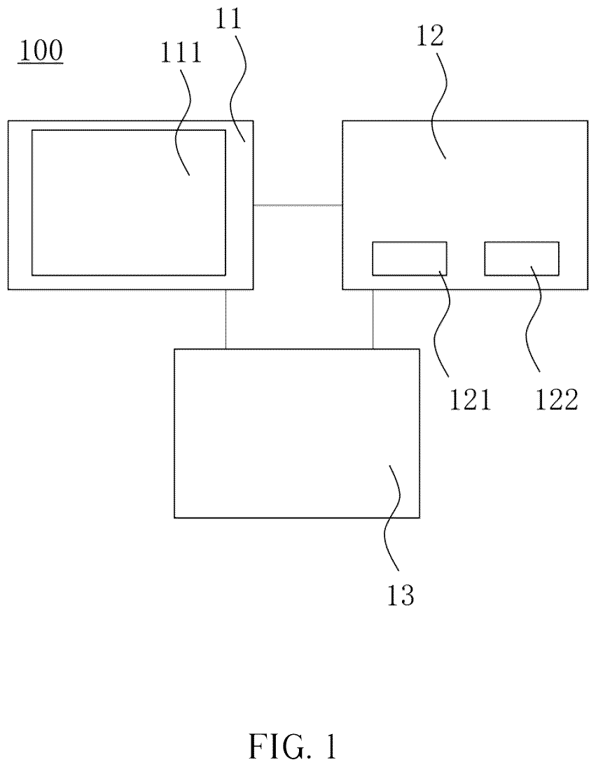

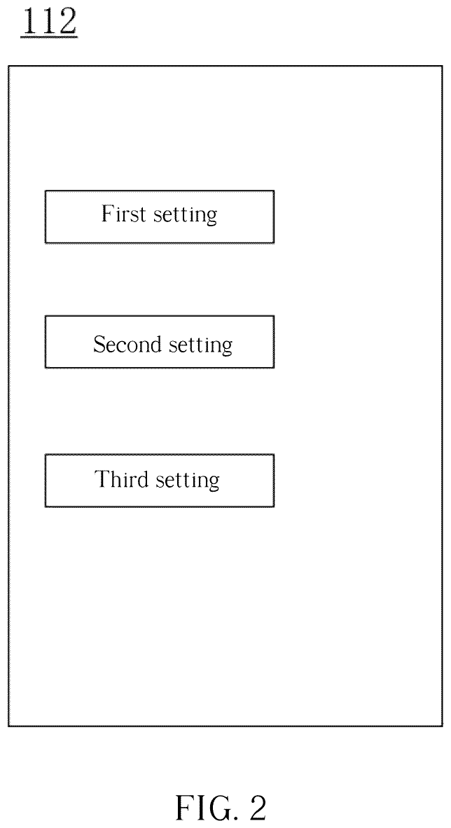

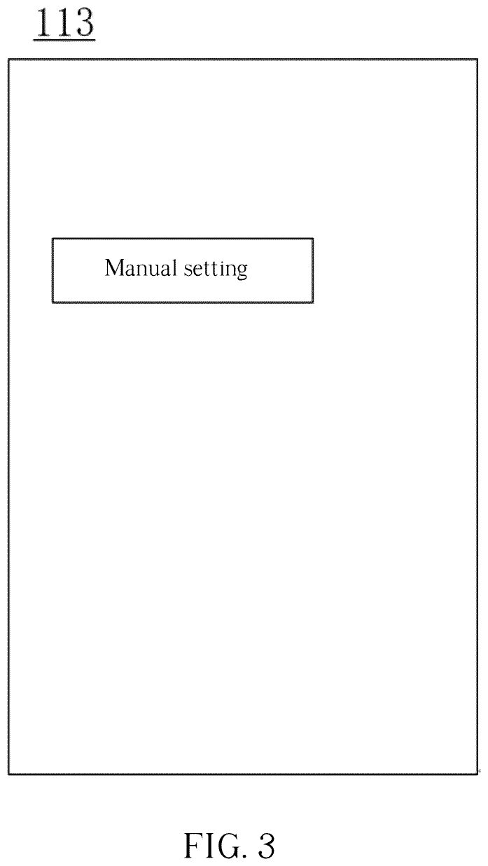

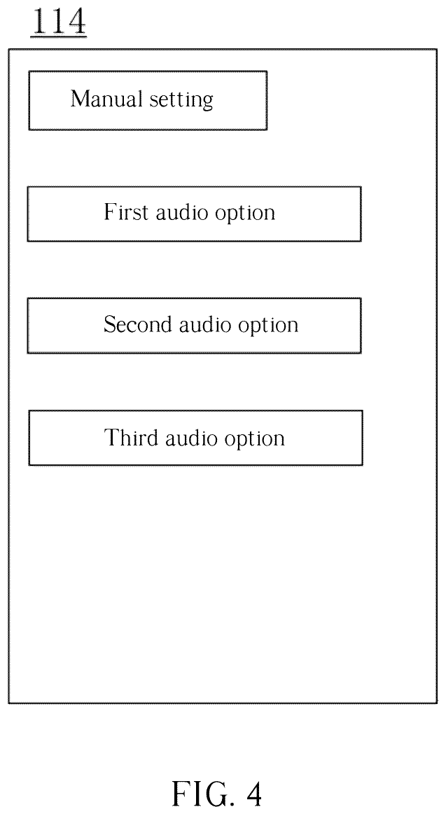

Please refer to FIG. 1, FIG. 2, FIG. 3, and FIG. 4, FIG. 1 is a functional block diagram of an audio setup management system according to an embodiment of the present invention. FIG. 2 is a diagram of an audio setup according to an embodiment of the present invention. FIG. 3 is a diagram of a manual audio determination setting according to an embodiment of the present invention. FIG. 4 is a diagram of audio options according to an embodiment of the present invention. The present invention provides an audio setup management system 100. The audio setup management system 100 includes a display module 11, an audio module 12, and a management module 13. The display module 11 has a display surface 111, and the display surface 111 displays an audio setup 112. The audio setup 112 includes at least one setting. The audio module 12 is coupled to the display module 11. The management module 13 is respectively coupled to the display module 11 and the audio module 12 for controlling the display module 11 and the audio module 12. When the management module 13 selects one of the at least one setting in the audio setup 112, the display surface 111 displays a manual audio determination setting 113. The management module 13 further selects a manual setting from the manual audio determination setting 113, and the display surface 111 displays audio options 114. The management module 13 then selects one of the audio options 114, and the management module 13 controls the audio module 12 to connect in response to the one of the audio options 114. In such a manner, a purpose of customizing a selection of each audio option can be achieved by manually operating the manual audio determination setting.

As shown in FIG. 1, FIG. 2, FIG. 3, and FIG. 4, the audio setup management system 100 is suitable for smartphones, tablets, notebooks, or all-in-one computers that support sound card functions (e.g., speakers, microphones, and USB audio devices). The display module 11 could be a smartphone display screen, a tablet display screen, a notebook display screen, or a display screen of an all-in-one computer. The audio module 12 is used for audio output and input. The management module 13 is used to control the display module 11 and the audio module 12. In a specific implementation, the management module 13 could configure a default audio setup, manage an audio setup set by a user, process a routing of an audio session (i.e., determining which audio output device to use for audio stream output and which audio input device to use for audio stream input) and audio peripheral plug-in/out events (e.g., USB, HDMI, or headphone plug-in/out), maintain lists of available audio input devices and audio output devices, and determine priorities of various audio input devices and audio output devices with reference to previous user habits.

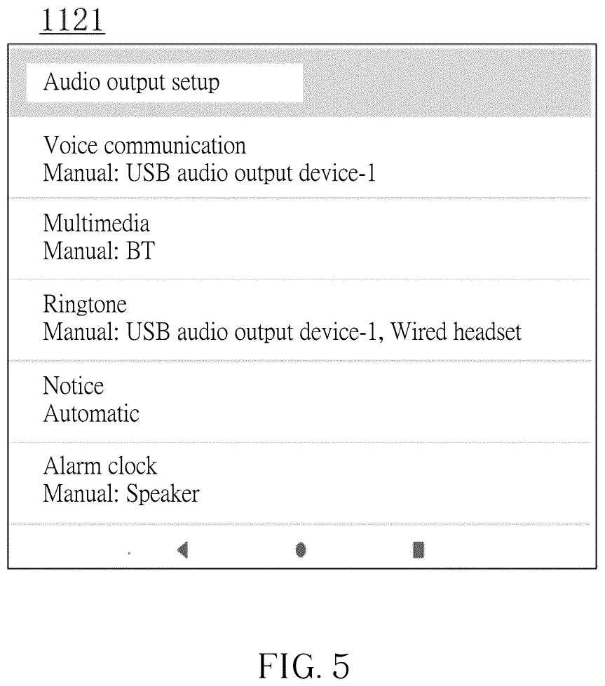

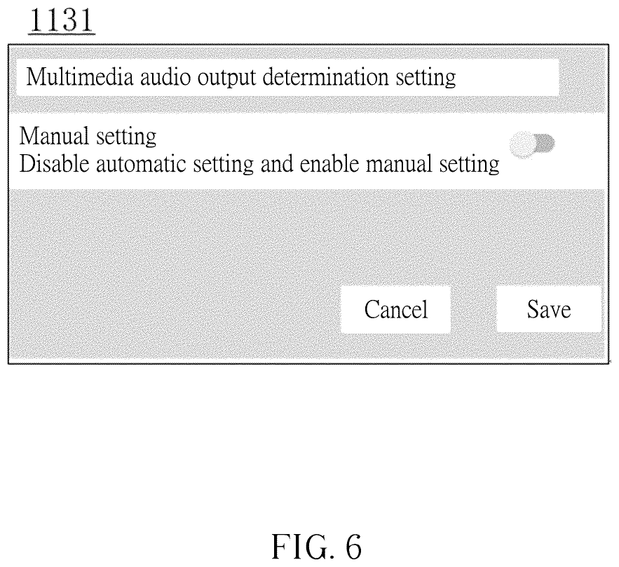

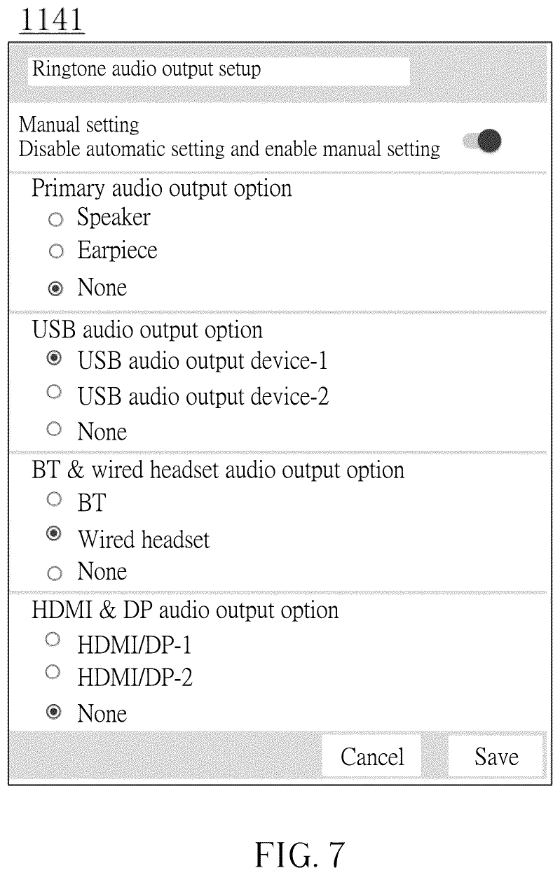

Please also refer to FIG. 5, FIG. 6, and FIG. 7. FIG. 5 is a diagram of an audio output setup according to an embodiment of the present invention. FIG. 6 is a diagram of a manual audio output determination setting according to an embodiment of the present invention. FIG. 7 is a diagram of audio output options according to an embodiment of the present invention. The audio setup management system 100 includes an audio output unit 121 for audio output. The management module 13 is used to perform selection in the audio setup 112. The audio setup 112 includes at least one audio output setting. When the management module 13 selects one of the at least one audio output setting, the display surface 111 displays a manual audio output determination setting 1131. The management module 13 further selects a manual setting in the manual audio output determination setting 1131, and the display surface 111 displays audio output options 1141. The management module 13 then selects one of the audio output options 1141, and the management module 13 controls the audio output unit 121 to connect in response to the one of the audio output options 1141. In a specific implementation, the audio setup 112 includes an audio output setup 1121, and the audio output setup 1121 divides various types of audio output devices into groups. Built-in speakers and built-in receivers are divided into a primary audio output group, all connected USB audio output devices are divided into a USB audio output device group, BT (Bluetooth) and wired headsets are divided into a BT and wired headset group, and all HDMI/DP audio output devices are divided into a HDMI/DP (Display Port) audio output device group. Output devices within the same group cannot be combined (i.e., cannot output audio concurrently), but output devices of different groups can be combined to output audio simultaneously. For example, an incoming call ringtone could be output simultaneously through a wired headset and a built-in speaker. An audio output stream setup includes an automatic mode and a manual mode. In the automatic mode, a playback device for each type of audio output stream is selected automatically according to a usual user habits. For example, for a multimedia audio stream, a last connected external audio device is selected for audio stream output if there are pluggable audio output devices. If no external audio output device is connected, an audio output device is selected according to priority. In the manual mode, audio output options configured for each group are combined to form an output device list.

As shown in FIGS. 5, 6, and 7, when each of the audio output options 1141 is selected as “None”, the management module 13 prompts for re-selection of at least one of the audio output options 1141. In a specific implementation, the USB audio output device group lists all connected USB audio output devices. If a previously selected USB audio output device is subsequently disconnected, it is regarded as the USB audio output device group being set to “None”. The HDMI/DP audio output device group lists all connected HDMI/DP audio output devices. If a previously selected HDMI/DP audio output device is disconnected, it is regarded as the HDMI/DP audio output device group being set to “None”. If every group in the audio output options 1141 is set to “None”, the management module 13 prompts the user that the setup is invalid and needs to be reconfigured.

As shown in FIGS. 5, 6, and 7, when the manual setting in the manual audio output determination setting 1131 is not selected by the management module 13, the management module 13 queries a list of pluggable audio output devices connected to the audio module 12. If the list of pluggable audio output devices is not empty, the management module 13 selects a last connected audio output device from the list for audio output. If the list is empty, the management module 13 selects a built-in audio output device for audio output. In a specific implementation, the types of pluggable audio output devices include: USB, HDMI, wired headset, and BT. If a previous manual ringtone setup includes built-in speaker, USB speaker, wired headset, and HDMI-1, and currently connected pluggable audio peripherals include wired headset, HDMI-1, and USB headset, pluggable audio output devices corresponding to a ringtone output stream are calculated to be built-in speaker, wired headset, and HDMI-1 (these three audio output devices output audio simultaneously). If a previous multimedia setup is the automatic mode, currently connected pluggable audio peripherals include wired headset, HDMI-1, and USB speaker, and a last connected peripheral is wired headset, a pluggable audio output device corresponding to a multimedia output stream is calculated to be wired headset.

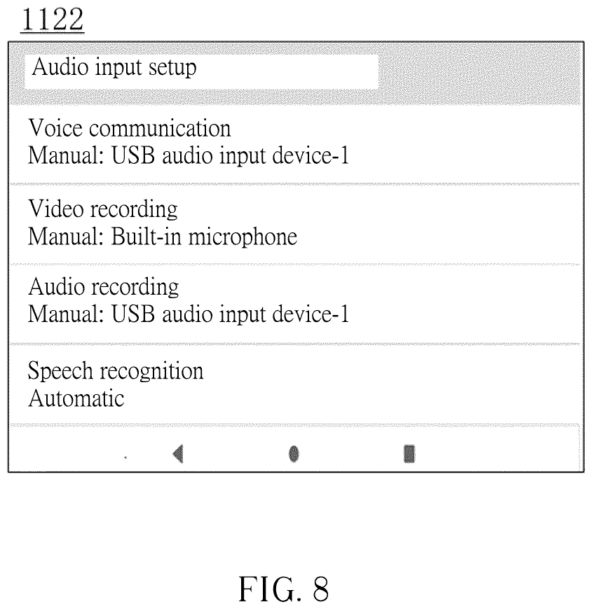

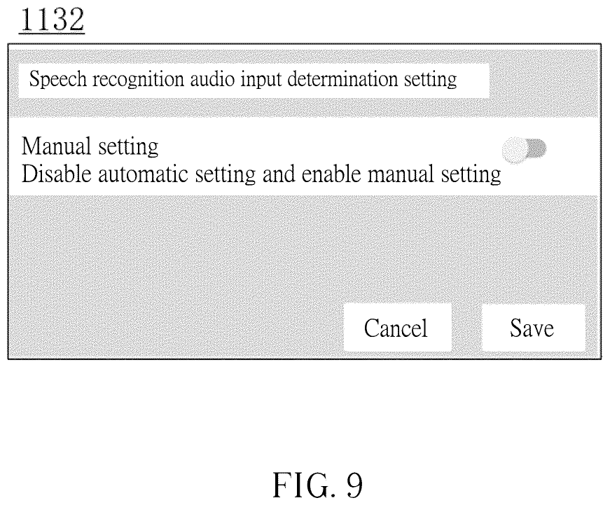

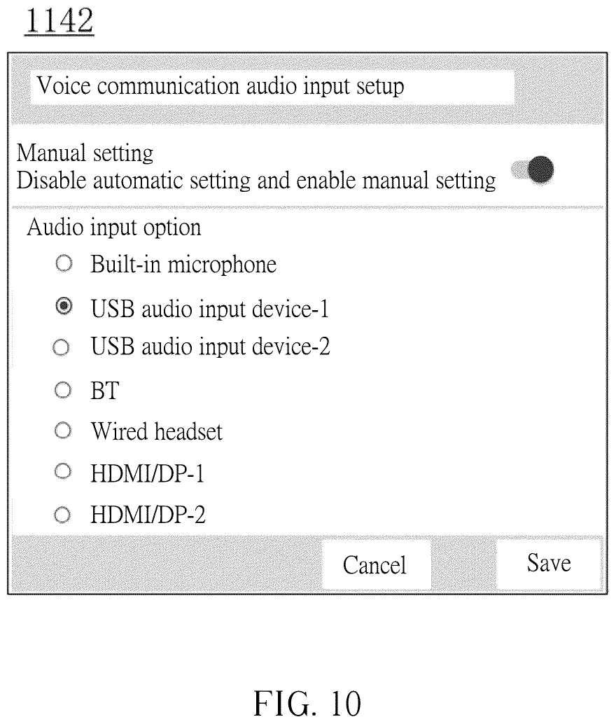

Please also refer to FIG. 8, FIG. 9, and FIG. 10. FIG. 8 is a diagram of an audio input setup according to an embodiment of the present invention. FIG. 9 is a diagram of a manual audio input determination setting according to an embodiment of the present invention. FIG. 10 is a diagram of audio input options according to an embodiment of the present invention. The audio setup management system 100 includes an audio input unit 122, and the audio input unit 122 is used for audio input. The management module 13 is used to perform selection in the audio setup 112. The audio setup 112 includes at least one audio input setting. When the management module 13 selects one of the at least one audio input setting, the display surface 111 displays a manual audio input determination setting 1132. When the management module 13 further selects a manual setting in the manual audio input determination setting 1132, the display surface 111 displays audio input options 1142. When the management module 13 then selects one of the audio input options 1142, the management module 13 controls the audio input unit 122 to connect in response to the one of the audio input options 1142. In a specific implementation, the audio setup 112 includes an audio input setup 1122, which specifies an audio input device for an audio input stream. The audio input stream includes (but not limited thereto): voice communication, video recording, audio recording, and speech recognition. The audio input options 1142 include (but not limited thereto): automatic, built-in microphone, all HDMI microphones, all USB input devices, BT, and wired headset.

As shown in FIGS. 8, 9, and 10, when the manual setting in the manual audio input determination setting 1132 is not selected by the management module 13, the management module 13 queries a list of pluggable audio input devices connected to the audio module 12, and the management module 13 selects an audio input device with the highest priority from the list for audio input. In a specific implementation, all connected USB audio input devices are listed, and all connected HDMI/DP audio input devices are listed. If HDMI/DP audio input is not supported, an HDMI/DP audio input option is not provided. If a previously selected USB audio input device is subsequently disconnected, the audio input setup for this audio input stream is regarded as being in the automatic mode. If a previously selected HDMI/DP audio input device is disconnected, the audio input setup for this audio input stream is also regarded as being in the automatic mode. The priorities of audio input devices are as follows: BT>wired headset>USB microphone (or headset)>built-in microphone>HDMI microphone. For example, if a previous speech recognition setup is USB microphone (Brand 1) and currently connected pluggable audio input devices include: wired headset and USB microphone (Brand 2), the audio input device is selected based on the aforesaid priorities, thereby resulting in selection of wired headset since USB microphone (Brand 1) is not currently available. If USB microphone (Brand 1) is reconnected and speech recognition is restarted, the audio input device could be selected as USB microphone (Brand 1).

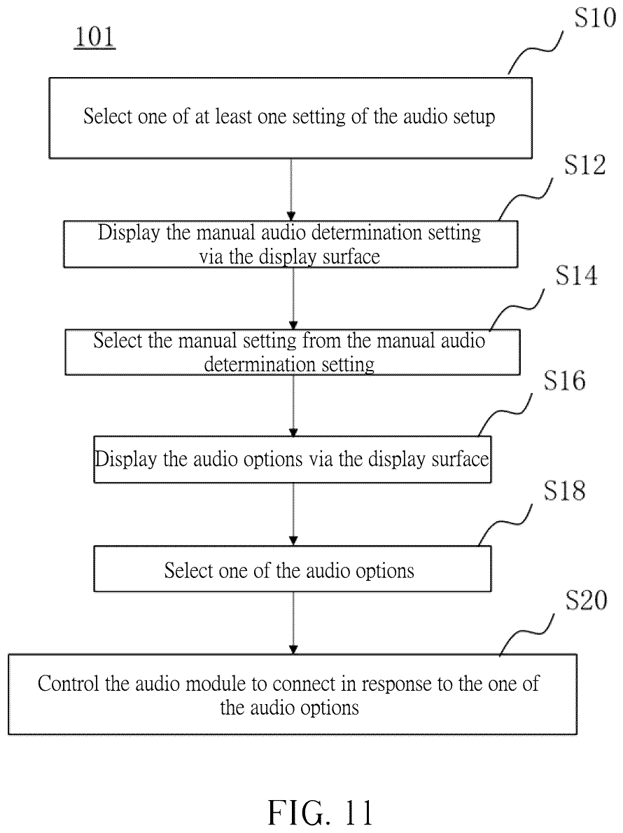

As shown in FIG. 11, which is a flowchart of an audio setup management method according to an embodiment of the present invention, the present invention further provides an audio setup management method 101, which can be applied to the audio setup management system 100 as described in FIGS. 1 to 10. The audio setup management system 100 includes the display module 11, the audio module 12, and the management module 13. The display module 11 includes the display surface 111, and the display surface 111 displays the audio setup 112. The audio setup 112 has at least one setting. The audio module 12 is coupled to the display module 11. The management module 13 is coupled to the display module 11 and the audio module 12 for controlling the display module 11 and the audio module 12. The audio setup management method 101 includes the following steps. First, perform step S10: select one of at least one setting of the audio setup 112. Next, perform step S12: display the manual audio determination setting 113 via the display surface 111. Then, perform step S14: select a manual setting from the manual audio determination setting 113. Subsequently, perform step S16: display the audio options 114 via the display surface 111. Next, perform step S18: select one of the audio options 114. Then, perform step S20: control the audio module 12 to connect in response to the one of the audio options 114. In such a manner, the purpose of customizing a selection of each audio option can be achieved by manually operating the manual audio determination setting.

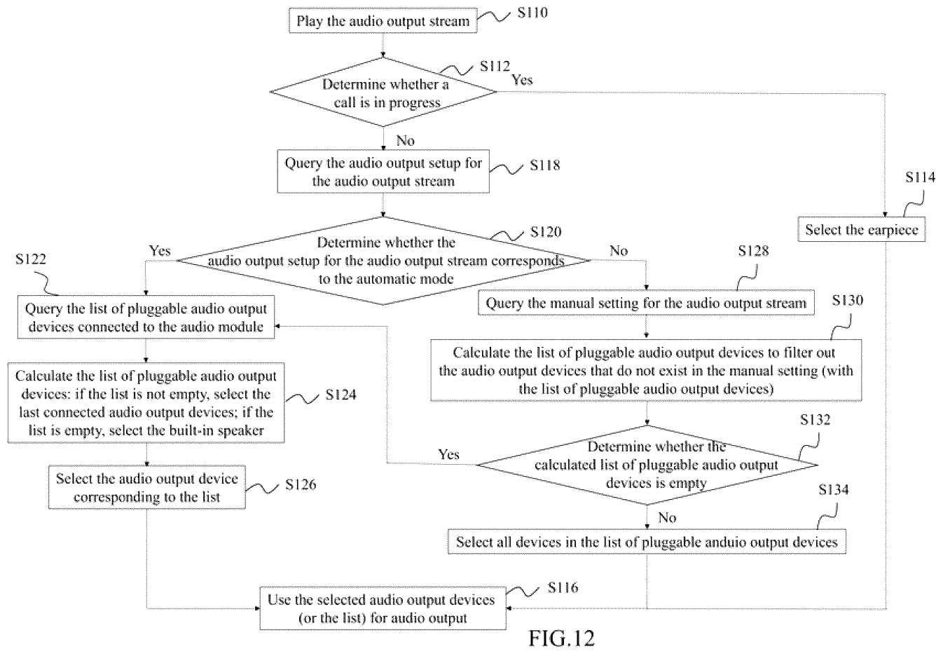

Please also refer to FIG. 12, which is a flowchart of an audio output setup management method according to one embodiment of the present invention. The user selects one of at least one audio output setting from the audio setup 112. The display surface 111 displays the manual audio output determination setting 1131. The user selects a manual setting from the manual audio output determination setting 1131, and the display surface 111 displays the audio output options 1141. The user selects one of the audio output options 1141, and the audio output unit 121 is controlled to connect in response to the one of the audio output options 1141 for audio output. If all of the audio output options 1141 are set to “None”, the audio setup management system 100 prompts the user to reselect at least one of the audio output options 1141. When the manual setting in the manual audio output determination setting 1131 is not selected, the audio setup management system 100 queries the list of pluggable audio output devices connected to the audio module 12. If the list is not empty, a last connected audio output device in the list is selected for audio output. If the list is empty, a built-in audio output device is selected for audio output. In a specific implementation, first, perform step S110: play an audio output stream. Next, perform step S112: determine whether a call is in progress. If yes, perform step S114: select an earpiece. Then, perform step S116: use a selected audio output device (or the list) for audio output. If not, perform step S118: query the audio output setup for the audio output stream. Subsequently, perform step S120: determine whether the audio output setup for the audio output stream corresponds to the automatic mode. If yes, perform step S122: query the list of pluggable audio output devices connected to the audio module 12. Then, perform step S124: calculate the pluggable audio output devices. If the list is not empty, select a last connected audio output device. If the list is empty, select a built-in speaker. Then, perform step S126: select an audio output device corresponding to the list. If not, perform step S128: query the manual setting for the audio output stream. Then, perform step S130: calculate the list of pluggable audio output devices to filter out audio output devices that do not exist in the manual setting (with the list of pluggable audio output devices). Then, perform step S132: determine whether the calculated list of pluggable audio output devices is empty. If not, perform step S134: select all devices in the list of pluggable audio output devices. Then, perform step S116. If yes, perform step S122. As such, the management module 13 could process a routing of an audio session, determine which audio output device to use for audio stream output, process audio peripheral plug-in/out events (e.g., USB, HDMI, headphone plug-in/out), maintain a list of available audio output devices, and determine priorities of various audio output devices with reference to previous user habits.

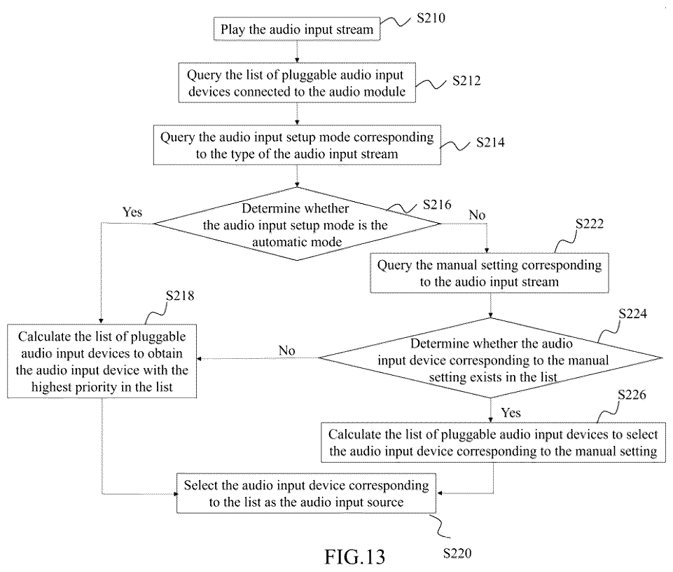

Please also refer to FIG. 13, which is a flowchart of an audio input setup management method according to one embodiment of the present invention. The audio input setup management method includes the following steps. The user selects one of at least one audio input setting from the audio setup 112, and the display surface 111 displays the manual audio input determination setting 1132. The user selects a manual setting from the manual audio input determination setting 1132, and the display surface 111 displays the audio input options 1142. The user selects one of the audio input options 1142, and the audio input unit 122 is controlled to connect in response to the one of the audio input options for audio input. If the manual setting in the manual audio input determination setting 1131 is not selected, the audio setup management system 100 queries the list of pluggable audio input devices connected to the audio module 12, and an audio input device with the highest priority is selected for audio input. In a specific implementation, first, perform step S210: play an audio input stream. Next, perform step S212: query the list of pluggable audio input devices connected to the audio module 12, and add a built-in device in the list. Then, perform step S214: query an audio input setup mode corresponding to the type of the audio input stream. Then, perform step S216: determine whether the audio input setup mode is the automatic mode. If yes, perform step S218: calculate the list of pluggable audio input devices to obtain an audio input device with the highest priority in the list. Then, perform step S220: select an audio input device corresponding to the list as an audio input source. If not, perform step S222: query the manual setting corresponding to the audio input stream. Then, perform step S224: determine whether an audio input device corresponding to the manual setting exists in the list. If not, perform step S218. If yes, perform step S226: calculate the list of pluggable audio input devices to select an audio input device corresponding to the manual setting. Then, perform step S220. As such, a router that processes an audio session can automatically determine which audio input device to use for audio stream input, and can also process audio peripheral plug-in/out events (e.g., USB, HDMI, or headphone plug-in/out) to automatically maintain a list of available audio input devices and determine the priority of each audio input device based on previous user habits.

In summary, the present invention provides the audio setup management system and the audio setup management method thereof. The audio setup management system includes the display module, the audio module, and the management module. The display module has the display surface for displaying the audio setup including at least one setting. The audio module is coupled to the display module. The management module is coupled to the display module and the audio module for controlling the display module and the audio module. The management module selects one of the at least one setting from the audio setup. After the management module selects the one of the at least one setting from the audio setup, the display surface displays the manual audio determination setting. The management module then selects the manual setting from the manual audio determination setting, and the display surface displays the audio options. The management module selects one of the audio options and controls the audio module to connect in response to the one of the audio options. In such a manner, the purpose of customizing a selection of each audio option can be achieved by manually operating the manual audio determination setting.

Although the present invention has been described with reference to the accompanying drawings, the embodiments disclosed in the drawings are intended to exemplify preferred embodiments of the present invention and should not be construed as limiting the present invention. The proportions in the drawings do not represent actual component proportions and are used only to clearly describe the required components.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An audio setup management system comprising:
a display module having a display surface, the display surface displaying an audio setup, wherein the audio setup comprises at least one setting;
an audio module coupled to the display module; and
a management module coupled to the display module and the audio module for controlling the display module and the audio module;
wherein after the management module selects one of the at least one setting from the audio setup, the display surface displays a manual audio determination setting;
after the management module selects a manual setting from the manual audio determination setting, the display surface displays audio options;
after the management module selects one of the audio options, the management module controls the audio module to connect in response to the one of the audio options.

2. The audio setup management system of claim 1, wherein the audio module comprises an audio output unit for audio output, the audio setup comprises at least one audio output setting, and after the management module selects one of the at least one audio output setting, the display surface displays a manual audio output determination setting;
after the management module selects the manual setting from the manual audio output determination setting, the display surface displays audio output options;
after the management module selects one of the audio output options, the management module controls the audio output unit to connect in response to the one of the audio output options.

3. The audio setup management system of claim 2, wherein when none of the audio output options is enabled, the management module prompts to reselect at least one of the audio output options.

4. The audio setup management system of claim 2, wherein when the manual setting in the manual audio output determination setting is not selected, the management module queries a list of pluggable audio output devices connected to the audio module;
when the list is not empty, the management module selects a last connected audio output device from the list for audio output;
when the list is empty, the management module selects a built-in audio output device for audio output.

5. The audio setup management system of claim 1, wherein the audio module comprises an audio input unit for audio input, the audio setup comprises at least one audio input setting, and after the management module selects one of the at least one audio input setting, the display surface displays a manual audio input determination setting;
after the management module selects the manual setting from the manual audio input determination setting, the display surface displays audio input options;
after the management module selects one of the audio input options, the management module controls the audio input unit to connect in response to the one of the audio input options.

6. The audio setup management system of claim 5, wherein when the manual setting in the manual audio input determination setting is not selected, the management module queries a list of pluggable audio input devices connected to the audio module, and selects a first-priority audio input device from the list for audio input.

7. An audio setup management method applied to an audio setup management system, the audio setup management method comprising:
selecting one of at least one setting from an audio setup;
displaying a manual audio determination setting via a display surface;
selecting a manual setting from the manual audio determination setting;
displaying audio options via the display surface;
selecting one of the audio options; and
controlling an audio module to connect in response to the one of the audio options.

8. The audio setup management method of claim 7, wherein the audio setup management method further comprises:
selecting one of at least one audio output setting from the audio setup;
displaying a manual audio output determination setting via the display surface;
selecting the manual setting from the manual audio output determination setting;
displaying audio output options via the display surface;
selecting one of the audio output options;
controlling an audio output unit to connect in response to the one of the audio output options; and
outputting audio via the audio output unit.

9. The audio setup management method of claim 8, wherein the audio setup management method further comprises:
prompting to reselect at least one of the audio output options when none of the audio output options is selected.

10. The audio setup management method of claim 8, wherein the audio setup management method further comprises:
querying a list of pluggable audio output devices connected to the audio module when the manual setting in the manual audio output determination setting is not selected;
selecting a last connected audio output device for audio output when the list is not empty; and
selecting a built-in audio output device for audio output when the list is empty.

11. The audio setup management method of claim 7, wherein the audio setup management method further comprises:
selecting one of at least one audio input setting from the audio setup;
displaying a manual audio input determination setting via the display surface;
selecting the manual setting from the manual audio input determination setting;
displaying audio input options via the display surface;
selecting one of the audio input options;
controlling an audio input unit to connect in response to the one of the audio input options; and
inputting audio via the audio input unit.

12. The audio setup management method of claim 11, wherein the audio setup management method further comprises:
querying a list of pluggable audio input devices connected to the audio module when the manual setting in the manual audio input determination setting is not selected; and
selecting a first-priority audio input device from the list for audio input.
